(19) United States
(12) Patent Application Publication
(10) Pub. No.: US 2025/0261658 A1
(43) Pub. Date: Aug. 21, 2025

(54) MICROWAVE PASTEURIZATION FACILITY INCORPORATING A VENTILATION COOLING SYSTEM

(71) Applicant: SAIREM SOCIETE POUR L'APPLICATION INDUSTRIELLE DE LA RECHERCHE EN ELECTRONIQUE ET MICRO ONDES, DECINES CHARPIEU (FR)

(72) Inventors: Bertrand DEPAGNEUX, VILLEFRANCHE SUR SAONE (FR); Moulay TAOUFIK, SAINT GENIS LAVAL (FR); Alexandre THILLIER, LYON (FR); Eric TRESCARTE, SAINT GEORGES DE RENEINS (FR)

(21) Appl. No.: 18/871,021

(22) PCT Filed: May 24, 2023
(86) PCT No.: PCT/FR2023/050731

§ 371 Date: Dec. 2, 2024

(30) Foreign Application Priority Data
Jun. 3, 2022 (FR) FR2205360

(51) Int. Cl. A23B 2/08; A23B 2/00; A23B 2/22; H05B 6/70; H05B 6/78; H05B 6/80

(52) U.S. Cl. CPC A23B 2/08; A23B 2/001; A23B 2/22; H05B 6/707; H05B 6/782; H05B 6/80; H05B 2206/044; H05B 2206/045

(57) ABSTRACT

A microwave pasteurization facility for pasteurizing food products contained in packages that are hermetically sealed by an impermeable film, the facility including at least: - a microwave cavity; - a conveyor line conveying the packages through the microwave cavity; - at least one microwave generator designed to generate and propagate through the microwave cavity microwave radiation that heats the food products on the conveyor line; - a ventilation cooling system that injects cold air into the microwave cavity by means of at least one air distribution plenum transparent to the microwaves which extends continuously inside the microwave cavity, along and above the conveyor line, and is provided with holes for distributing air along and opposite the conveyor line.

### CROSS REFERENCE TO RELATED APPLICATIONS

This application is a National Stage of PCT Application No. PCT/FR PCT/FR2023/050731 filed on May 24, 2023, which claims priority to French Patent Application No. 22/05360 filed on Jun. 3, 2022, the contents each of which are incorporated herein by reference thereto.

### TECHNICAL FIELD

The present disclosure relates to a microwave pasteurization facility for pasteurizing food products contained in hermetically closed packages.

More particularly, it relates to a microwave pasteurization facility comprising a ventilation cooling system.

The present disclosure also relates to a microwave pasteurization method implemented by such a pasteurization facility.

The present disclosure finds application in the agri-food industry.

### BACKGROUND

In a known manner, pasteurization is a process used in the agri-food industry consisting of a heat treatment of foodstuffs which are first heated at moderate temperature between 60° C. and 100° C. for a given duration, then rapidly cooled immediately afterwards.

Pasteurization is used to significantly reduce the number of microorganisms/bacteria present in foodstuffs and which could be beneficial or harmful (salmonella, Listeria, Staphylococcus aureus, etc.) to humans. Thus, pasteurization of some foods, like dairy products (milk, eggs, or any preparation based on these ingredients like cheeses, yogurts), allows considerably reducing the risks of food poisoning, and guaranteeing health safety of people who have a fragile immune system (like children, pregnant women, elderly people) and for which these risks could be particularly dangerous.

The pathogenic bacteria responsible for food deterioration are also destroyed, which allows increasing their shelf life, while preserving their taste and organoleptic qualities, a pasteurized product could even be considered to be fresh (pasteurized fresh milk, fresh cream, etc.).

The pasteurization temperature and the duration during which it is applied to a foodstuff depend on the thermal resistances of the harmful micro-organisms contained therein (generally, they are established on the basis of the most resistant microorganism).

A pasteurized food should be hermetically packaged (with or without a protective atmosphere or under vacuum) to prevent external microorganisms from contaminating the foodstuff, and be refrigerated preferably in order to slow down the development of residual microorganisms that would not have been completely destroyed during the pasteurization. This is why the foodstuffs are packaged with materials/packages capable of being in contact therewith, so that said materials/packages do not alter them/contaminate them. These materials/packages should also have some thermal resistance in order not to soften during the implementation of the pasteurization method.

Pasteurization by microwaves is a recent pasteurization method still under development. In comparison with the conventional pasteurization method which are based on a transmission of heat from the outside towards the inside by thermal conduction over the surface of the foodstuffs (for example by steam, hot air, or hot water), pasteurization by microwaves is based on spatially uniform absorption by the foodstuffs of a microwave radiation. The possibility of applying this microwave radiation inside the foodstuff allows heating it more rapidly, i.e. significantly reducing the pasteurization time by passing from several hours with the conventional process to a few minutes in this case. The rapidity of the microwave treatment allows guaranteeing better taste and organoleptic qualities, in particular for heat-sensitive foodstuffs.

Pasteurization by microwaves is applied to one or several food product(s) contained in a package hermetically closed by a sealed film and which could, for example, be a sealed film bag or a tray sealed by a film peelable seal; such a sealed film being made, for example, of a synthetic plastic material or of a plant-derived plastic material, like, for example, a starch-based one.

During heating of the package by the microwaves, a temperature rise occurs within the latter. This temperature rise induces an evaporation of the water present in the packaged food products(s) and therefore an increased in the pressure. If the pressure exerted by the heated packaged food product(s) is too high, a rupture/explosion of the plastic bag or film of the package might occur (in particular at the level of weld areas), thereby making the package non-sealed and therefore unsuitable for sale and consumption because it no longer fills its preservation function over time.

To address this problem, one of the known solutions, in particular of the document ITVI20130082, consists in cooling packages in the form of trays during pasteurization thereof, in order to reduce the air temperature and therefore the local pressure exerted by steam under their sealed films. In the document ITVI20130082, the trays are conveyed on a conveyor line, which comes in and comes out of a microwave cavity used as a heating tunnel. In order to cool the films of the trays, ventilation devices are arranged along the microwave cavity, opening onto its upper face and interposed between microwave generators. Ventilation devices consist of fans injecting air throughout injection ducts opening at a point above the conveyor line. Nevertheless, the proposed solution has the following drawback: the films of the trays are cooled only intermittently during passage thereof under the injection ducts, all the more so since the speed of the air injected over the sealed films is not enough to promote a significant heat dissipation because of the wide diameters used for such injection pipes. Thus, the time for heat exchange for reducing the pressure exerted under the sealed film is too short, implying that the risk of rupture of the sealed film remains and therefore the sealing properties of the trays are not guaranteed.

### BRIEF SUMMARY

The proposed disclosure includes of a pasteurization facility for microwave pasteurization of food products contained in packages hermetically closed by a sealed film, the pasteurization facility comprising at least:
a microwave cavity;
a conveyor line passing through said microwave cavity for conveying the packages;
at least one microwave generator coupled to at least one microwave guide opening into the microwave cavity, to generate and propagate a microwave radiation inside the latter and heat the food products on the conveyor line;
a ventilation cooling system designed to inject air inside the microwave cavity;
said pasteurization facility being characterized in that the ventilation cooling system comprises at least one air distribution plenum formed of a tubular body which extends continuously inside the cavity microwave, along and above the conveyor line, said at least one air distribution plenum being made of a material transparent to the microwave radiation and being provided with air distribution orifices distributed along and opposite the conveyor line.

A ventilation cooling system such as that one provided in the proposed disclosure has the following advantages:
the at least one air distribution plenum being arranged along and above the conveyor line, and being provided with air distribution orifices also distributed along and opposite the conveyor line, it continuously cools the sealed films of the packages all the time during which they are conveyed by the conveyor line inside the microwave cavity,
the at least one air distribution plenum is arranged in the microwave cavity such that it is interposed between an upper face of the cavity and the conveyor line.

Being manufactured from a material transparent to the microwave radiation, it does not disturb heating of the food products by the microwave radiations when these are propagated inside the microwave cavity. By “material transparent to the microwave radiation”, it should be understood that said material does not absorb the microwave radiations.

Advantageously, the conveyor line is manufactured from a material transparent to microwaves, like, for example, polypropylene or polyethylene.

Thus, throughout the duration of the pasteurization heat treatment, a thermal equilibrium is maintained at the sealed films of the packages. The heat exchange between the sprayed cold air and the sealed films reduces the air temperature and induces a back pressure which reduces the pressure difference between the outside and the inside of the packages. The risk of rupture of the sealed films or of the welds is then eliminated. Consequently, throughout its at least one air distribution plenum, the proposed pasteurization facility favorably addresses the problem of heating food products by microwaves while preserving their sealing properties.

According to two variants of the present disclosure, the ventilation cooling system is shaped so that the at least one air distribution plenum injects air constantly/continuously, or pulsed air at a higher pressure, intermittently or in pulses, inside the microwave cavity.

According to another variant of the present disclosure, a smart cooling system could also be implemented, which would project air, at a greater or lesser pressure over the sealed film of the packages, upon passage thereof under each of the air distribution orifices of the at least one air distribution plenum, provided that the distance between two air distribution orifices is at least equal to the distance separating two packages on the conveyor line.

According to a feature of the present disclosure, the at least one microwave generator comprises one or several microwave generator(s) coupled to several microwave guides opening into the microwave cavity and distributed along the conveyor line, and the at least one air distribution plenum extends at least between two microwave guides among the several microwave guides.

Depending on the length of the conveyor line which depends on the desire to apply the pasteurization method simultaneously to food products contained in several packages, the at least one microwave generator may comprise one or several microwave generator(s) coupled to as many microwave guides opening into the microwave cavity and distributed along the conveyor line. When several microwave generators are in presence along the conveyor line and therefore of the microwave cavity, the electromagnetic fields induced by the microwave radiations emitted by each of the microwave generators form an electromagnetic field having a uniform intensity. Advantageously, the packages are thus subjected, continuously throughout the duration of conveyance thereof in the microwave cavity, to the same intensity of the electromagnetic field and therefore heated at a stabilized pasteurization temperature.

In the case where the pasteurization facility comprises several microwave guides distributed along the conveyor line for continuous heating of the food products during conveyance thereof, the at least one air distribution plenum extends at least between two microwave guides in order to be able to continuously cool the sealed films of the packages during conveyance thereof between said two microwave guides.

According to an embodiment of the present disclosure, the at least one microwave guide comprises at least one upper microwave guide, opening above and opposite the conveyor line, the at least one air distribution plenum being interposed between said at least one upper microwave guide and said conveyor line.

According to an embodiment of the present disclosure, the at least one upper microwave guide comprises at least two upper microwave guides, and the at least one air distribution plenum extends at least between said two upper microwave guides.

According to an embodiment of the present disclosure, the at least one microwave guide comprises at least one lower microwave guide, opening below and opposite the conveyor line, said conveyor line then being interposed between the at least one air distribution plenum and said at least one lower microwave guide.

As indicated before, according to different embodiments of the present disclosure, the pasteurization facility may comprise, for heating the food products, one or several microwave generator(s), as well as one or several waveguide(s) shaped so as to propagate the microwave radiations emitted by the microwave generator(s) in the microwave cavity. The one or several microwave guide(s) may be arranged so as to propagate the microwave radiations above the conveyor line and/or below, thereby meaning that the microwave guides open into the microwave cavity through its upper face and/or its lower face, hence respectively the designations of upper microwave guide and lower microwave guide.

The at least one air distribution plenum being shaped so as to cool the sealed films of the packages while they are simultaneously heated by the microwave radiations, if the at least one microwave guide comprises one or several upper microwave guide(s), then the latter is interposed in the microwave cavity between the conveyor line and the upper microwave guide(s). It should be understood that, in order to continuously cool the packages during conveyance thereof in the microwave cavity, if the at least one microwave guide comprises at least two upper microwave guides, the at least one air distribution plenum extends at least between the at least two upper microwave guides.

It is also possible to consider heating the food products by incorporating to the pasteurization facility only one microwave generator which is connected to several upper microwave guides which consist of dispatcher waveguides/power dividers.

According to different embodiments, it is also possible to incorporate, in the pasteurization facility, at least one microwave generator coupled to at least one lower microwave guide, provided that the conveyor line is also manufactured from a material transparent to microwaves, the at least one lower microwave guide then propagating a microwave radiation under the conveyor line and therefore under the package.

In this case, this means that the conveyor line is interposed between the at least one air distribution plenum and the at least one lower microwave guide. Advantageously, arranging microwave generators and microwave guides above and below the conveyor line allows heating, in a more uniform and homogenous manner, the surface but also the core of the food products, and thus reducing the duration of the pasteurization treatment as well as the pasteurization temperature.

According to a feature of the present disclosure, the ventilation cooling system comprises at least one ventilation unit, such as blower or fan or pump, connected to the at least one air distribution plenum and designed to suck in air outside the microwave cavity in order to inject it into the at least one air distribution plenum.

According to a feature of the present disclosure, the at least one ventilation unit has an air flow rate comprised between 100 and 1,000 m³/h.

In other words, in addition to the at least one air distribution plenum, the ventilation cooling system comprises at least one ventilation unit which could be a fan, or a pump, or a blower like in the case of the preferred embodiment of the present disclosure. The ventilation unit is shaped so as to suck in air outside the microwave cavity and inject cold air inside the at least one an air distribution plenum. The ventilation unit has an air flow rate comprised between 100 and 1,000 m³/h (typically 280 m³/h) in order to inject air into the at least one air distribution plenum air at different cooling temperatures and for several injection speeds, for the cooling by ventilation to be advantageously adapted to all types of food products to be treated by the pasteurization facility, more specifically at the temperature at which they are heated by the microwave radiations.

According to a feature of the present disclosure, the at least one air distribution plenum has a tubular section in which the air distribution orifices are provided.

According to a feature of the present disclosure, the tubular section of the at least one air distribution plenum has a transverse dimension comprised between 50 mm and 100 mm, for example 75 mm.

The at least one air distribution plenum is in the form of a tubular body which could have different geometric shapes (round, square, etc.) having a transverse dimension comprised between 50 mm and 100 mm, for example 75 mm, advantageously to best adapt to the dimensions of the microwave cavity and of the products to be pasteurized. As mentioned before, the tubular body is provided with air distribution orifices distributed along and opposite the conveyor line in order to project air over the packages.

According to an embodiment of the present disclosure, the at least one air distribution plenum comprises one or several air distribution plenum(s) extending over at least 90% of the length of the microwave cavity measured along the conveyor line.

Advantageously, by extending over at least 90% of the length of the microwave cavity, the at least one air distribution plenum allows continuously cooling the sealed films of the packages, and therefore maintaining them at their thermal equilibrium level, throughout the duration of pasteurization and routing thereof on the conveyor line from the inlet of the microwave cavity towards its outlet. The at least one air distribution plenum, according to the embodiment of the present disclosure, may comprise: either one single air distribution plenum extending over at least 90% of the length of the microwave cavity; or several air distribution plenums with identical or different lengths which, when placed end-to-end along and above the conveyor line, extend over the at least 90% of the length of the microwave cavity.

According to a feature of the present disclosure, the ventilation cooling system is designed to inject air at a cooling temperature comprised between 4° C. and 65° C.

According to a feature of the present disclosure, the ventilation cooling system is designed to inject air, at the outlet of the air distribution orifices, at a propagation speed comprised between 10 m/s and 15 m/s.

In other words, the ventilation cooling system is shaped so that the cold air is sprayed over the packages at the outlet of the distribution orifices of the at least one air distribution at a propagation speed comprised between 10 m/s and 15 m/s and that it is characterized by a cooling temperature comprised between 4° C. and 65° C., the propagation speed and the cooling temperature being adapted: to the pasteurization temperature applied to all types of food products to treat them thermally, and to dissipate the heat and reduce the pressure exerted locally on the sealed film inside the packages during heating thereof in order to avoid a rupture of said sealed film or of the weld.

According to a feature of the present disclosure, the air distribution orifices are located at a separation height above the conveyor line, said separation height being comprised between 10 cm and 15 cm.

For the cold air to be able to cool the sealed films of the packages efficiently, it should be projected thereabove and the closest thereto. This is why it is provided for the distribution orifices being arranged above the conveyor line at a separation height comprised between 10 cm and 15 cm, this height being selected in particular according to the height of the microwave cavity. According to a feature of the present disclosure, the air distribution orifices have an orifice dimension comprised between 3 mm and 10 mm, for example 5 mm.

In order to advantageously accelerate and project the air over the packages at a propagation speed adapted to maintain a thermal equilibrium at the level of their sealed film, the distribution orifices are intended to have an orifice dimension that could be comprised between 3 mm and 10 mm, for example 5 mm.

According to a feature of the present disclosure, the air distribution orifices are spaced apart from each other by a given minimum spacing distance, said minimum spacing distance being comprised between 40 mm and 50 mm.

In order to advantageously cool down continuously throughout the duration of pasteurization the packages during conveyance thereof inside the microwave cavity, the distribution orifices are more or less evenly distributed over the at least one air distribution plenum according to a minimum spacing distance comprised between 40 mm and 50 mm, this minimum spacing distance being selected according to the length of the microwave cavity.

According to an embodiment of the present disclosure, the material transparent to the microwave radiation is selected from among polypropylene, polyethylene and polytetrafluoroethylene.

The air distribution plenum being arranged in the microwave cavity, and for example between the conveyor line and one or several microwave generator(s) shaped so as to emit a microwave radiation above the package, it is manufactured from a material transparent to the microwaves so as not to disturb the microwave radiation(s) and thus heating of the food products. According to different embodiments, the plenum may be manufactured with polypropylene, polyethylene, or polytetrafluoroethylene (that is to say Teflon).

The present disclosure also relates to a pasteurization method for microwave pasteurization of food products contained in packages hermetically closed by a sealed film, said pasteurization method being implemented within a pasteurization facility such as that one described hereinabove, and which comprises at least:
a conveying step during which the packages are conveyed on the conveyor line,
a heating step, taking place simultaneously with the conveying step, during which the at least one microwave generator generates and propagates via the at least one microwave guide a microwave radiation to heat the food products on the conveyor line,
a ventilation cooling step, taking place simultaneously with the conveying step and with the heating step, during which air is injected along and above the conveyor line throughout the distribution orifices provided in the at least one air distribution plenum.

### BRIEF DESCRIPTION OF THE DRAWINGS

Other features and advantages of the present disclosure will become apparent upon reading the detailed description hereinafter of a non-limiting example of implementation, made with reference to the appended figures, wherein:

FIG. 1 is a schematic view illustrating the operating principle of the pasteurization facility;

FIG. 2 is a schematic view illustrating the pasteurization facility in an example of the present disclosure, which comprises two microwave cavities placed end-to-end and crossed by the conveyor line, each of the two microwave cavities comprising an air distribution plenum supplied with air by its own ventilation unit;

FIG. 3 is a schematic and partial view of the pasteurization facility of FIG. 2, showing the inside of the two microwave cavities;

FIG. 4 is a schematic bottom and partial view of the pasteurization facility of FIG. 2.

### DETAILED DESCRIPTION

The pasteurization facility 1 of the present disclosure includes at least:
at least one microwave cavity 3;
a conveyor line 4 passing through the at least one microwave cavity 3 through openings located at the level of its two lateral walls, and which is intended to convey packages 2;
at least one microwave generator 5 coupled to at least one microwave guide 51, 52 opening into the at least one microwave cavity 3, to generate and propagate inside the latter a microwave radiation W heating the food products contained in the packages 2 conveyed on the conveyor line 4;
a ventilation cooling system designed to inject air A inside the at least one microwave cavity 3 and over the packages 2, in order to reduce the air temperature and the pressure difference between the inside and the outside of the packages 2 during heating thereof, and eliminate the risk of rupture/explosion of their sealed film and/or of their welds.

The at least one microwave generator 5 is shaped so as to generate a microwave radiation W for a frequency band between 300 MHz and 10 GHz, the pasteurization facility 1 thus covering the frequencies authorized/allocated by standards in ISM band (Industrial, the Scientific and Medical) for heating/pasteurization of food products in different regions of the world (for example: 915 MHz and 2.45 GHz in Europe and in the United States, 896 MHz in the United Kingdom, 922 MHz in Australia, etc.); as well as other frequencies currently under study in the agri-food research environment and potentially promising, like the frequency at 433 MHz.

The conveyor line 4 is manufactured from a material transparent to microwaves, for example polypropylene or polyethylene, so that it does not absorb the microwave radiations W emitted by the at least one microwave generator 5, so that they would not heat the packages 2 as expected.

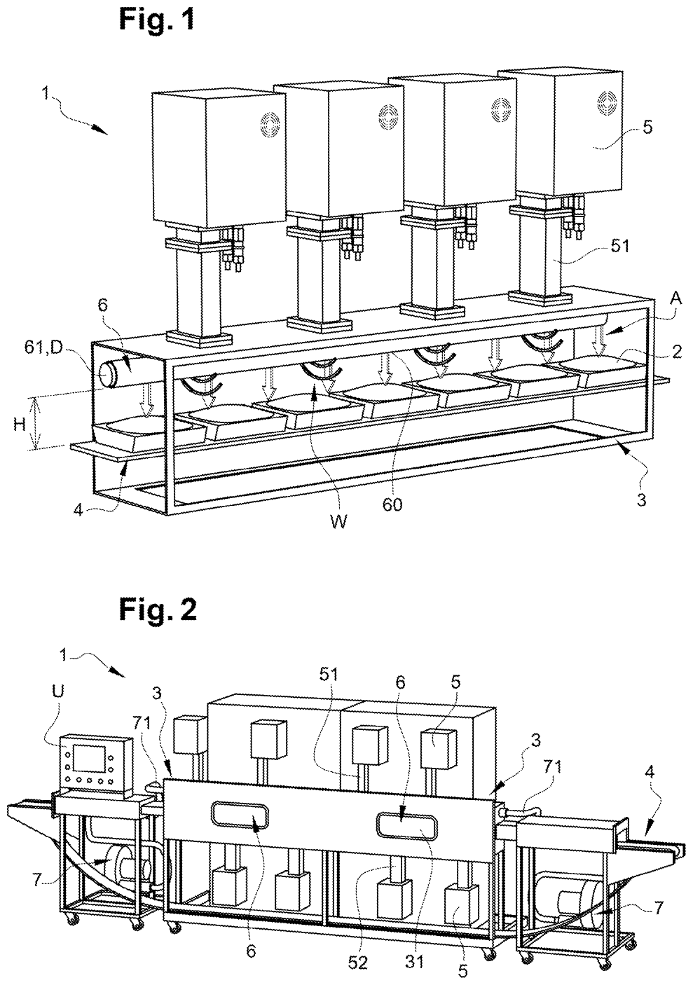

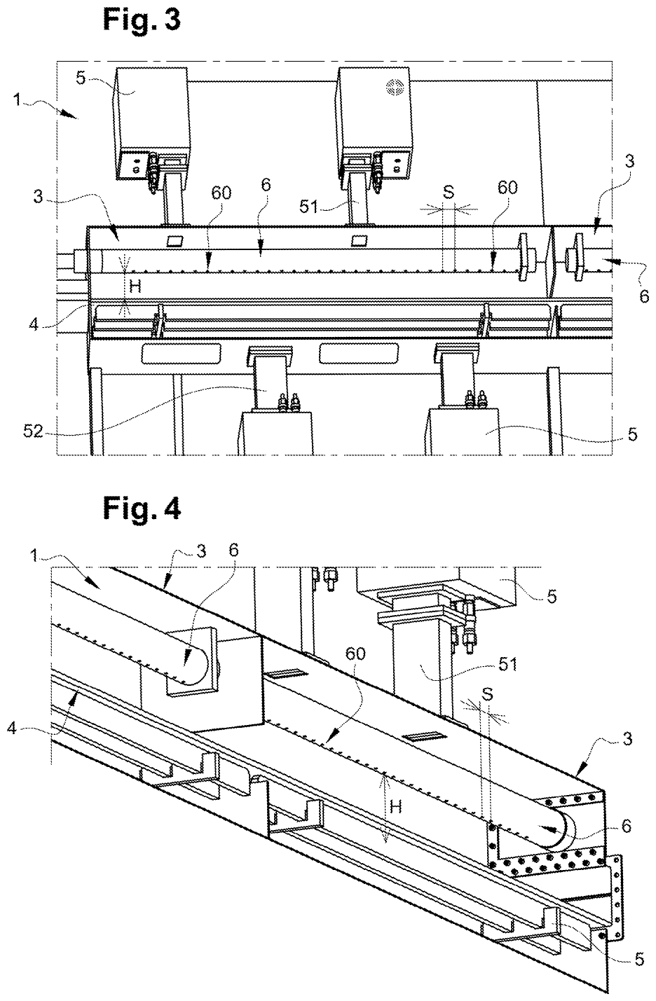

Referring to FIG. 1 to FIG. 3, several embodiments of the present disclosure are possible.

The pasteurization facility 1 may comprise one single microwave cavity 3, as illustrated in FIG. 1, or several microwave cavities 3 placed end-to-end and all crossed by the conveyor line 4, as illustrated in FIGS. 2 to 4, which correspond to an illustrative and non-limiting embodiment of the present disclosure for which two microwave cavities 3 of the same length are used, for example each being 1.5 m long.

Also, the pasteurization facility 1 may comprise, according to the length of the at least one microwave cavity 3 and depending on whether the pasteurization facility 1 is intended to simultaneously and uniformly pasteurize several food products during conveyance thereof in the at least one microwave cavity 3, several microwave guides 51, 52 opening into the at least one microwave cavity 3 and distributed along the conveyor line 4 and propagating microwave radiations W. In the case where the pasteurization facility 1 comprises several microwave guides, these may be coupled each to a different microwave generator 5; or these may be connected to the same microwave generator 5, the microwave guides then being associated with power dispatchers/dividers.

According to different variants of the present disclosure, the at least one microwave guide may be an upper microwave guide 51, respectively a lower microwave guide 52, opening into the at least one microwave cavity 3 by an upper face of the microwave cavity 3, respectively by a lower face of the microwave cavity 3, and exposing to the microwave radiations W the top, respectively the bottom, of the conveyor line 4 and therefore of the packages 2 conveyed above.

In the example illustrated in FIG. 1, the pasteurization facility comprises four upper microwave guides 51 distributed along the conveyor line 4 and each coupled to a microwave generator 5. In the embodiment illustrated in FIGS. 2 to 4, each of the microwave cavities 3 is connected to two upper microwave guides 51 and two lower microwave guides 52, arranged in an interposed manner so that the packages 2 during conveyance thereof along the conveyor line 4 are alternately heated from above and then from below; each of the two upper microwave guides 51 and of the two lower microwave guides 52 being coupled to a microwave generator 5. As indicated before, arranging microwave generators 5 and microwave guides above and below the conveyor line 4 allows volumetrically propagating the microwave radiations W in the at least one microwave cavity 3, and thus heat in a more uniform and homogenous manner the surface but also the core of the food products contained in the packages 2.

The ventilation cooling system comprises:
at least one cooling unit 7, like a fan, a blower or a pump, which sucks in air A outside the at least one microwave cavity 3;
at least one air distribution plenum 6 connected to the outlet of the cooling unit 7 through a connecting hose 71, receiving the air A, and which extends inside the at least one microwave cavity 3, along and above the conveyor line 4.

Optionally, a refrigeration unit is incorporated into the cooling system to cool the air A that is drawn at room temperature outside the microwave cavity 3.

In the case where the at least one microwave cavity 3 is connected to at least one upper microwave guide 51, the at least one air distribution plenum 6 is interposed between the at least one upper microwave guide 51 and the conveyor line 4.

In the case where the at least one microwave cavity 3 is connected to at least one lower microwave guide 52, this means that it is the conveyor line 4 which is interposed between the at least one air distribution plenum 6 and the at least one lower microwave guide 52.

In the case where the at least one microwave cavity 3 is connected to at least two microwave guides (whether they consist of upper microwave guides 51 or lower microwave guides 52), the at least one air distribution plenum 6 extends at a minimum between these at least two microwave guides to cool the packages 2 during the time interval while they are conveyed by the conveyor line 4 between the at least two microwave guides.

In the case where the pasteurization facility 1 comprises one single microwave cavity 3, only one ventilation system, comprising a cooling unit 7 and an air distribution plenum 6, is necessary for cooling the packages 2. In the case it would comprise several microwave cavities 3, different solutions of implementation are possible:
each of the several microwave cavities 3 is associated with a cooling system comprising at least one cooling unit 7 and at least one air distribution plenum 6.
the cooling system comprises one single ventilation unit 7 and the lateral walls of the several microwave cavities 3 are shaped so as to have openings allowing making one single plenum air distribution 6 pass through the set.
the cooling system comprises two ventilation units 7 and two air distribution plenums 6 such that, if the pasteurization facility has n microwave cavities: the first cooling unit 7 injects air A in a first direction into a first air distribution plenum 6 which extends longitudinally in x microwave cavities; the second cooling unit 7 injects air A in a second direction, opposite to the first direction, into a second air distribution plenum 6 which extends longitudinally in the other (n−x) microwave cavities 3.

In the embodiment of FIGS. 2 to 4, the cooling system comprises two ventilation units 7 each injecting air A, in opposite directions, into two air distribution plenums 6 each associated with one of the two microwave cavities 3.

The at least one air distribution plenum 6 is present as a tubular body which could have different geometric shapes (round, square, etc.) having a transverse dimension D comprised between 50 mm and 100 mm to best adapt to the dimensions of the at least one microwave cavity 3 and of the products to be pasteurized. Thus, the or each air distribution plenum 6 is formed of a tubular body which extends continuously along and above the conveyor line 4; this tubular body extends continuously in the direction in which it extends continuously over its entire length, from one of its two ends up to the other one of its two ends. In the context of the present disclosure, it is clear that the or each air distribution plenum 6 does not necessarily extend over the entire length of the conveyor line 4, depending on whether the pasteurization facility 1 comprises one single air distribution plenum 6 or comprises several air distribution plenums 6 aligned along the conveyor line 4.

In order not to absorb the microwave radiations W and not disturb the pasteurization of the food products, the at least one air distribution plenum 6 is manufactured from a material transparent to microwaves, like polypropylene, polyethylene or polytetrafluoroethylene (Teflon).

In order to continuously cool the packages 2 during conveyance thereof along the at least one microwave cavity 3, the at least one air distribution plenum 6:
extends over at least 90% of the length of the at least one microwave cavity 3; and
are provided with air distribution orifices 60 distributed along and opposite the conveyor line 4, and which project air A over the packages 2.

In the context of the present disclosure, if the pasteurization facility 1 comprises one single air distribution plenum 6, then the latter has a length that is at least equal to 90% of the length of the at least one microwave cavity 3; and if the pasteurization facility 1 comprises several aligned air distribution plenums 6, then the sum of the lengths of these several air distribution plenums is at least equal to 90% of the length of the at least one cavity. In other words, the at least one air distribution plenum 6 may comprise one or several air distribution plenum(s) 6 extending over at least 90% of the length of the microwave cavity 3 measured along the conveyor line 4.

The air distribution orifices 60 are intended to:
be evenly distributed over the entire length of the at least one air distribution plenum 6 while being spaced apart from one another by a minimum spacing distance S comprised between 40 mm and 50 mm according to the length of the at least one microwave cavity 3;
have an orifice dimension comprised between 3 mm and 10 mm to propagate air A at a suitable speed over the packages 2 to reduce the pressure difference at the level of their sealed film;
be positioned at a separation height H of the packages 2 comprised between 10 cm and 15 cm so that the air A projection could effectively reduce the pressure difference, the separation height H being selected according to the height of the at least one microwave cavity 3.

In the embodiment of FIGS. 2 to 4, for which each of the two microwave cavities 3 is for example 1.5 m long, the two air distribution plenums 6 are cylinders having a transverse dimension D of 75 mm and are 1.4 m long. Both of them comprise thirty-two air distribution orifices 60 having an orifice dimension of 5 mm, spaced apart from each other by 40 mm and placed opposite the packages 2 at a separation height H comprised between 10 cm and 15 cm, so that air is projected the closest to the packages 2 for the best possible efficiency.

The at least one ventilation unit 7 is shaped so as to have an air flow rate comprised between 100 and 1,000 m³/h, typically 280 m³/h, in order to inject, into the at least one air distribution plenum 6, air A at different cooling temperatures, which could be comprised between 4° C. and 65° C., and for several injection speeds, so that the ventilation cooling is adapted to all types of food products to be treated by the pasteurization facility, and at the heating temperature and the internal pressure of the packages 2 when subjected to the microwave radiations W. Depending on the characteristics of the at least one ventilation unit 7 and the at least one air distribution plenum 6, air A at the outlet of the air distribution orifices 60 of the at least one air distribution plenum 6 is projected over the packages 2 at a propagation speed comprised between 10 m/s and 15 m/s.

The pasteurization facility 1 implements a microwave pasteurization method comprising at least three steps taking place simultaneously:
a conveying step during which the packages 2 are conveyed on the conveyor line 4 inside the at least one microwave cavity 3, that being so for a predetermined conveying speed;
a heating step during which the at least one microwave generator 5 generates, at an emission frequency, and propagates inside the at least one microwave cavity 3, via the at least one microwave guide, a microwave radiation W to heat the food products on the conveyor line 4;
a ventilation cooling step during which the at least one ventilation unit 7 of the ventilation cooling system injects air A into the at least one air distribution plenum 6 passing through the inside of the at least one microwave cavity 3, along and above the conveyor line 4, which projects air A over the packages 2, by means of its air distribution orifices 60, to cool them and reduce the pressure difference at the level of their sealed film.

The pasteurization facility 1 is controlled by means of a control unit U through which an operator:
defines all or part of a set of parameters involved in the steps of the pasteurization method, comprising at least: the duration of the pasteurization treatment, the emission frequency of the microwave radiations W generated by the at least one microwave generator 5, the speed of the conveyor line, the air flow rate of the at least one ventilation unit 7 and the temperature at which the air A outside the pasteurization facility should optionally be cooled;
and monitors the proper progress of the pasteurization treatment, the pasteurization facility 1 could, for example, comprise sensors returning the conveying speed, the air flow rate, the temperature inside the at least one microwave cavity 3.

In the embodiment of the present disclosure, each of the two microwave cavities 3 is provided with a window 6 enabling the operator to examine the inside of the microwave cavity 3 and to perform a visual inspection to verify whether the pasteurization method takes place as expected, for example by verifying whether the packages 2 have not undergone a rupture/explosion of the sealed film.

During the ventilation cooling step, the operator can select whether the at least one ventilation unit 7, over the duration of the pasteurization treatment, injects into the at least one air distribution plenum 6 air A continuously or intermittently (the operator could, in the second case, parameterize the time interval separating two injections).

1. A pasteurization facility for microwave pasteurization of food products contained in packages hermetically closed by a sealed film, the pasteurization facility comprising at least:
a microwave cavity;
a conveyor line passing through the microwave cavity for conveying the packages;
at least one microwave generator coupled to at least one microwave guide opening into the microwave cavity, to generate and propagate a microwave radiation inside the latter and heat the food products on the conveyor line;
a ventilation cooling system designed to inject air inside the microwave cavity;
wherein the ventilation cooling system comprises at least one air distribution plenum formed of a tubular body which extends continuously inside the microwave cavity, along and above the conveyor line, the at least one air distribution plenum being made of a material transparent to the microwave radiation and being provided with air distribution orifices distributed along and opposite the conveyor line.

2. The pasteurization facility according to claim 1, wherein the at least one microwave generator comprises one or several microwave generator(s) coupled to several microwave guides opening into the microwave cavity and distributed along the conveyor line, and the at least one air distribution plenum extends at least between two microwave guides among the several microwave guides.

3. The pasteurization facility according to claim 1, wherein at least one microwave guide comprises at least one upper microwave guide, opening above and opposite the conveyor line, the at least one air distribution plenum being interposed between the at least one upper microwave guide and the conveyor line.

4. The pasteurization facility according to claim 3, wherein the at least one upper microwave guide comprises at least two upper microwave guides, and the at least one air distribution plenum extends at least between the two upper microwave guides.

5. The pasteurization facility according to claim 1, wherein the at least one microwave guide comprises at least one lower microwave guide, opening below and opposite the conveyor line, the conveyor line then being interposed between the at least one air distribution plenum and the at least one lower microwave guide.

6. The pasteurization facility according to claim 1, wherein the ventilation cooling system comprises at least one ventilation unit, such as blower or fan or pump, connected to the at least one air distribution plenum and designed to suck in air outside the microwave cavity in order to inject it into the at least one air distribution plenum.

7. The pasteurization facility according to claim 6, wherein the at least one ventilation unit has an air flow rate comprised between 100 and 1,000 m³/h.

8. The pasteurization facility according to claim 1, wherein the at least one air distribution plenum has a tubular section in which the air distribution orifices are provided.

9. The pasteurization facility according to claim 8, wherein the tubular section of the at least one air distribution plenum has a transverse dimension comprised between 50 mm and 100 mm, for example 75 mm.

10. The pasteurization facility according to claim 1, wherein the at least one air distribution plenum comprises one or several air distribution plenum(s) extending over at least 90% of a length of the microwave cavity measured along the conveyor line.

11. The pasteurization facility according to claim 1, wherein the ventilation cooling system is designed to inject air at a cooling temperature comprised between 4° C. and 65° C.

12. The pasteurization facility according to claim 1, wherein the ventilation cooling system is designed to inject air, at an outlet of the air distribution orifices, at a propagation speed comprised between 10 m/s and 15 m/s.

13. The pasteurization facility according to claim 1, wherein the air distribution orifices are located at a separation height above the conveyor line, the separation height being comprised between 10 cm and 15 cm.

14. The pasteurization facility according to claim 1, wherein the air distribution orifices have an orifice dimension comprised between 3 mm and 10 mm, for example 5 mm.

15. The pasteurization facility according to claim 1, wherein the air distribution orifices are spaced apart from each other by a given minimum spacing distance, the minimum spacing distance being comprised between 40 mm and 50 mm.

16. The pasteurization facility according to claim 1, wherein the material transparent to the microwave radiation is selected from among polypropylene, polyethylene and polytetrafluoroethylene.

17. A pasteurization method for microwave pasteurization of food products contained in packages hermetically closed by a sealed film, the pasteurization method being implemented within a pasteurization facility according to claim 1, and which comprises at least:
a conveying step during which the packages are conveyed on the conveyor line,
a heating step, taking place simultaneously in the conveying step, during which the at least one microwave generator generates and propagates via the at least one microwave guide a microwave radiation for heating the food products on the conveyor line,
a ventilation cooling step, taking place simultaneously with the conveying step and with the heating step, during which air is injected along and above the conveyor line throughout the air distribution orifices provided in the at least one air distribution plenum.

18. The pasteurization facility according to claim 4, wherein the at least one microwave guide comprises at least one lower microwave guide, opening below and opposite the conveyor line, the conveyor line then being interposed between the at least one air distribution plenum and the at least one lower microwave guide.

19. The pasteurization facility according to claim 18, wherein the ventilation cooling system comprises at least one ventilation unit, such as blower or fan or pump, connected to the at least one air distribution plenum and designed to suck in air outside the microwave cavity in order to inject it into the at least one air distribution plenum.

20. The pasteurization facility according to claim 19, wherein the at least one air distribution plenum has a tubular section in which the air distribution orifices are provided.
